(19) United States
(12) Patent Application Publication
(10) Pub. No.: US 2012/0129686 A1
(43) Pub. Date: May 24, 2012

(54) CATALYST FOR ELECTROCHEMICAL REACTIONS

(75) Inventors: Claudia Querner, Ludwigshafen (DE); Ekkehard Schwab, Neustadt (DE); Oemer Uensal, Mainz (DE); Sigmar Braeuninger, Hemsbach (DE); Thomas Justus Schmidt, Moerfelden-Walldorf (DE)

(73) Assignee: BASF SE, Ludwigshafen (DE)

(21) Appl. No.: 13/388,803

(22) PCT Filed: Jul. 28, 2010
(86) PCT No.: PCT/EP10/60936

§ 371 Date: Feb. 3, 2012

(30) Foreign Application Priority Data
Aug. 3, 2009 (EP) 09167063.8

(51) Int. Cl. B01J 21/18

(52) U.S. Cl. 502/185; 502/180

(57) ABSTRACT

Catalyst comprising a support and a catalytically active material for use as heterogeneous catalyst for electrochemical reactions, wherein the support is a carbon support having a BET surface area of less than 50 m²/g. The invention further relates to the use of the catalyst as electrode catalyst in a fuel cell.

The invention relates to a catalyst comprising a support and a catalytically active material for use as heterogeneous catalyst for electrochemical reactions. The invention further relates to the use of the catalyst.

Metals of the platinum group or alloy catalysts of the metals of the platinum group are usually used as catalysts for electrochemical reactions. As alloying component, use is generally made of transition metals, for example nickel, cobalt, vanadium, iron, titanium, copper, ruthenium, palladium, etc., in each case either individually or in combination with one or more further metals. Such catalysts are used particularly in fuel cells. The catalysts can be used both on the anode side and on the cathode side. On the cathode side in particular, it is necessary to use active catalysts which are also stable to corrosion. Alloy catalysts are generally used as active catalysts.

To obtain a high catalytic surface area, the catalysts are usually supported. Carbon is generally used as support. Carbon supports used usually have a high specific surface area which makes fine distribution of the catalyst nanoparticles possible. The BET surface area is generally above 100 m²/g. However, a disadvantage of these carbon supports, for example Vulcan XC72 having a BET surface area of about 250 m²/g or Ketjen Black EC-300J having a BET surface area of about 850 m²/g, is that these corrode very quickly. At potentials of 1.1 V, about 60% of the carbon of Vulcan XC72 corrode to form carbon dioxide as a result of oxidation over a period of 15 hours. In the case of carbon blacks having a smaller specific surface area, for example DenkaBlack having a BET surface area of about 60 m²/g, the corrosion stability of the support is higher since the graphitic content of the carbon black is higher. The corrosion loss is only 8% of the carbon after 15 hours at 1.1 V. The catalyst particles on carbon supports having a lower surface area are usually somewhat larger and are close to one another. However, this frequently leads to a decrease in performance since only a small part of the amount of catalytically active material applied to the support can be utilized catalytically.

Since fewer nucleation sites are available on low-surface-area carbon blacks compared to high-surface-area carbon blacks and crystal growth proceeds preferentially at existing nuclei, it is usually assumed that the production of finely divided catalyst particles on low-surface-area carbon blacks is more difficult. Since larger catalyst particles have a lower catalyst surface area, electrochemical reactions proceed with a lower conversion. Since the particles are closer together on low-surface-area carbon blacks, these can also agglomerate more quickly during operation and thereby suffer a further loss in catalytic surface areas. For this reason, active catalysts are usually produced using high-surface-area supports, i.e. supports having a BET surface area of more than 100 m²/g, e.g. Vulcan XC72 having a BET surface area of about 250 m²/g or Ketjen Black EC-300J having a BET surface area of about 850 m²/g.

The surface properties of the carbon supports and the catalysts produced thereon also have a substantial influence on the processability to form inks from which the electrodes are produced. Catalysts on very low-surface-area supports are usually more difficult to disperse in a stable fashion, which can make processing more difficult. This is apparent, for example, in the use of DenkaBlack having a BET surface area of about 60 m²/g.

Due to the support materials which are usually used at present, which are black, the catalysts produced and ultimately the electrodes for which the catalysts are used are also black. This leads to anodes and cathodes not being able to be distinguished visually. This can technologically lead to problems in the construction of fuel cells. It is therefore advantageous for anode and cathode to be color coded. Color coding by addition of additive components or a surface after-treatment is described, for example, in WO 2004/091024. However, a disadvantage of color coding is that a further substance has to be added. This can sometimes have adverse effects on the activity of the catalyst.

It is an object of the present invention to provide a catalyst for electrochemical reactions which has better corrosion resistance than catalysts known from the prior art.

The object is achieved by a catalyst comprising a support and a catalytically active material for use as heterogeneous catalyst for electrochemical reactions, wherein the support is a carbon support having a BET surface area of less than 50 m²/g.

An advantage of the use of a carbon support which has a BET surface area of less than 50 m²/g is that the corrosion stability is significantly improved compared to the supports known from the prior art. In addition, it has surprisingly been found that the power density of the catalyst does not decrease despite the lower surface area.

A further advantage of the catalyst of the invention is that it is, unlike the catalysts known from the prior art, not black but instead has a gray color. This makes it possible for the catalyst to be color coded purely by use of different supports. Thus, for example, a catalyst which is supported on a carbon support known from the prior art can be used as anode catalyst since this does not have to be as corrosion-stable as a cathode catalyst. The catalyst of the invention is then used as cathode catalyst. The different color makes clear assignment of anode catalyst and cathode catalyst possible, which reduces or can even eliminate the risk of mistaking the catalysts. When the carbon black is used as support for an electrocatalyst in a fuel cell, the color gives no improvement in the performance of the fuel cell but technologically simplifies distinguishing of anode and cathode, which, for example, makes further automation of the production process or assembly possible.

The BET surface area is usually determined by N₂ adsorption. However, it is also possible, as an alternative, to determine the total surface area by, for example, iodine adsorption, since the two values are usually very similar. The catalyst of the invention has a BET surface area of less than 50 m²/g. The BET surface area is preferably in the range from 20 to 30 m²/g.

Owing to the low BET surface area of the support, the graphitic content of the carbon black is relatively high. Thus, for example, graphite has a BET surface area of less than 10 m²/g. The low surface area improves the stability of the support to oxidative corrosion. This is particularly important for use as cathode material.

The external surface area of the support can, for example, be characterized by the CTAB value. The CTAB value is determined by adsorption of cetyltrimethylammonium bromide (CTAB). According to the invention, the carbon support has a CTAB surface area of less than 50 m²/g. The CTAB surface area is preferably in the range 20-30 m²/g.

The catalyst of the invention preferably has a ratio of BET surface area to CTAB surface area in the range from 1 to 1.1. A ratio of a value of close to 1 characterizes a relatively compact carbon black having few or very small pores.

The catalyst can be further characterized by the oil adsorption number (OAN). The oil adsorption number is, for example, determined by adsorption of dibutyl phthalate (DBP). As an alternative, adsorption of paraffin oil is also possible. The oil adsorption number is a measure of the absorption of liquid by carbon blacks. The oil adsorption number is reported in ml (DBP)/100 g (carbon black). In the case of the catalyst of the invention, the absorption of liquid by the carbon support is preferably in the range from 100 to 140 ml/100 g. The absorption of liquid is determined by the adsorption of DBP.

A further characteristic of the catalyst of the invention is the proportion of material which can be extracted by means of toluene, which is a measure of the contamination of the carbon black. With regard to the processability and possible poisoning of the catalyst, the proportion of material which can be extracted by means of toluene is less than 1%, preferably less than 0.1%.

The carbon support which is used for the catalyst of the invention has a significantly lighter color than the carbon blacks known from the prior art which are used as supports for electrocatalysts. The lighter color makes it possible to distinguish anode and cathode more easily, which, for example, makes automation of the production process or the assembly process of a fuel cell possible. The color can be quantified by colorimetric measurements. For this purpose, remission measurements, for example, are carried out. Here, both the light which is not absorbed and the light remitted from the support are measured as a function of the wavelength, for example in the range from 400 to 900 nm. As an alternative, measurements into the near infrared range or infrared range are also possible.

Catalysts produced from the carbon support known from the prior art, for example DenkaBlack, Vulcan XC72 or Ketjen Black EC-300J, or thereon absorb virtually all the light and the measured remission values are below about 2.5%. In contrast, the catalysts of the invention have a remission value which is greater than 2.5%, preferably greater than 3.5%. At a catalyst loading of about 30% by weight or less, remission values of at least 4% are measured. The values are usually up to about 5%, but can also exceed 5%.

Color values and color differences can be determined from the measured remission curves. Here, the curve is integrated according to spectral functions over the wavelength range to give three color coordinates which describe the shade of color and its lightness. A frequently used coordinate system is the CIE L*a*b* system. Here, L* is the lightness. The catalyst of the invention has a significantly higher lightness value than the catalysts known from the prior art. Thus, the L* value for the catalysts known from the prior art is, for example, in the range from 32 to 34, while the value for the catalysts of the invention is in the range from 35.3 to 36.5.

Color differences between a comparative sample and a reference are usually reported as ΔE*. Here:

ΔE*²=ΔL*²+Δa*²+Δb*²

where: ΔL*=L*_{comp}−L*_{ref}, Δa*=a*_{comp}−a*_{ref}, Δb*=b*_{comp}−b*_{ref}. Here, the index comp denotes the value for the comparative sample and the index ref denotes the value for the reference.

When ΔE* has a value of more than 5, this means that the comparative sample and the reference have different colors. A value for ΔE* of more than 1 indicates an appreciable color difference and a value for ΔE* of less than 0.5 means that the samples have no or virtually no difference in color. The difference between the catalysts known from the prior art and the catalyst of the invention has a value which sometimes corresponds to virtually a different color. In general, the color difference between the catalysts known from the prior art and the catalyst of the invention is ΔE*>2. The value of ΔE* is usually about 3.

The catalytically active material used comprises, for example, a metal of the platinum group, a transition metal or an alloy of these metals. The catalytically active material is preferably selected from among platinum and palladium and alloys of these metals and alloys comprising at least one of these metals. The catalytically active material is very particularly preferably platinum or an alloy comprising platinum. Suitable alloying metals are, for example, nickel, cobalt, iron, vanadium, titanium, ruthenium and copper, in particular nickel and cobalt. When an alloy is used, particular preference is given to a platinum-nickel alloy or a platinum-cobalt alloy. When an alloy is used as catalytically active material, the proportion of the metal of the platinum group in the alloy is preferably in the range from 40 to 80 atom %, more preferably in the range from 50 to 80 atom % and in particular in the range from 60 to 80 atom %.

As support for the catalyst, preference is given to using a carbon black. The carbon black can be produced by any process known to those skilled in the art. Carbon blacks which are normally used are, for example, furnace black, flame black, acetylene black or any other carbon black known to those skilled in the art.

The catalyst of the invention is used, for example, as electrode catalyst, preferably as cathode catalyst. The catalyst is particularly suitable for use as electrode catalyst, in particular as cathode catalyst, in a fuel cell.

### EXAMPLES

### Example 1

Comparison of the corrosion stabilities of the supports

The corrosion stability of the support was tested in a fuel cell assembly in which only the support instead of the catalyst was installed on the cathode side and nitrogen was introduced instead of the stream of air as carrier gas. The corrosion of the support is caused by reaction of the carbon with the water of the carrier gas to form carbon dioxide. The reaction rate is generally very slow. However, with increasing potential, in particular at a potential of more than 0.9 V relative to a standard hydrogen electrode (SHE), the liberation of carbon dioxide is accelerated, particularly at high temperatures.

For a first experimental measurement, the fuel cell is operated at a temperature of 180° C. and a potential of 1.1 V. The carbon dioxide liberated is determined and converted into the loss in mass of the support. It is found that a standard carbon support, for example Vulcan XC72, loses 7% of its weight after only one hour, 27% of its weight after 5 hours and 57% of its weight after 15 hours, in the form of carbon dioxide as a result of corrosion. DenkaBlack, which is known to be more stable to corrosion, loses 1% of its carbon after one hour, 3% after 5 hours and 7% after 15 hours.

The carbon black support according to the invention R1 has a BET surface area of 30 m²/g, a CTAB surface area of 29 m²/g, an oil adsorption number of 121 ml/100 g and an extractables content of 0.04%. The carbon black support according to the invention R1 loses only 0.2% of its carbon after one hour, 0.4% after 5 hours and 1.8% after a total time of 15 hours.

This means that corrosion of 1% of the support takes a few minutes in the case of Vulcan XC72, about one hour when using DenkaBlack and about 12 hours when using the support according to the invention (in each case at an applied potential of 1.1 V).

A second measurement was carried out analogously at 1.2 V in order to determine any continuing accelerated aging behavior. The results are qualitatively similar and are summarized in table 1.

TABLE 1
Weight loss of carbon blacks at 1.1 V and at 1.2 V

| Carbon black | BET | Weight loss at 1.1 V (%) | | | Weight loss at 1.2 V (%) | | |
|---|---|---|---|---|---|---|---|
| support | (m²/g) | after 1 h | after 5 h | after 15 h | after 1 h | after 5 h | after 15 h |
| Vulcan XC72 | 250 | 7 | 27 | 57 | 28 | 50 | 62 |
| Denka Black, 50% | 59 | 1 | 3 | 7 | 7 | 33 | 73 |
| Carbon black R1 | 30 | 0.2 | 0.4 | 1.8 | 1 | 6 | 22 |

### Example 2

Production of a platinum catalyst (30% by weight of Pt) on carbon black according to the invention R1

7.0 g of carbon black according to the invention R1 were dispersed in 500 ml of water and homogenized by means of an Ultra-Turrax at 8000 rpm for 15 minutes. 5.13 g of platinum nitrate were dissolved in 100 ml of water and slowly added to the carbon black dispersion. 200 ml of water and 800 ml of ethanol were subsequently added to the mixture and the mixture was refluxed for 6 hours. After cooling overnight, the suspension was filtered, the solid was washed free of nitrate with 2 l of hot water and dried under reduced pressure. The platinum loading produced in this way was 27.1% and the average crystallite size in the XRD was 3.4 nm.

### Example 3

Production of a platinum-nickel catalyst (20% by weight of Pt, 5% by weight of Ni) on carbon black according to the invention R1

In a first step, the platinum catalyst was produced by a method analogous to that described in example 2. A total of 24.0 g of carbon black according to the invention R1, 10.26 g of platinum nitrate and a total of twice the amount of solvent compared to example 1 were used for the batch. The platinum loading was 19.6% and the average crystallite size in the XRD was 3.0 nm.

The alloying with nickel was carried out in a second step. For this purpose, 18.0 g of the platinum catalyst were mixed with 9.70 g of nickel acetylacetonate, placed in a rotary tube and flushed with nitrogen for about 30 minutes. The mixture was subsequently heated to 110° C. under nitrogen and maintained at this temperature for 2 hours. The gas atmosphere was then changed over to an H₂/N₂ mixture (5% by volume of hydrogen in nitrogen), the furnace temperature was increased to 210° C. and held for 4 hours. The temperature was then increased to 600° C. and held for 3 hours. The furnace was subsequently flushed with nitrogen again and cooled. To remove unalloyed nickel, the catalyst was heated with 2 liters of 0.5 M sulfuric acid at 90° C. for one hour, then filtered, washed with 2.5 liters of hot water and finally dried. The metal loadings were 18.2% of Pt and 5.0% of Ni. The average crystallite size in the XRD was 3.4 nm with a lattice constant of 3.742 Å.

### Comparative Example 1

Production of a platinum catalyst (30% by weight of Pt) on Vulcan XC72

The platinum catalyst was produced by the method described in example 2 but using Vulcan XC72 carbon black instead of the carbon black according to the invention R1. The platinum loading of the resulting catalyst on Vulcan XC72 was 27.7% and the average crystallite size in the XRD was 1.9 nm.

### Comparative Example 2

Production of a platinum catalyst (30% by weight of Pt) on DenkaBlack (50% compressed)

The catalyst was likewise produced by a method analogous to that described in example 2 using DenkaBlack instead of the carbon black according to the invention R1. The platinum loading of the catalyst produced in this way was 27.7% and the average crystallite size in the XRD was 3.7 nm.

### Example 4

Determination of the mass-specific activity in the oxygen reduction reaction by means of a rotating disk electrode

The measurements by means of a rotating disk electrode are carried out in 1 M HClO₄ saturated with oxygen. The catalyst to be examined is applied to a vitreous carbon electrode having an area of 1 cm². The loading is about 15-20 μg of Pt. 5 cycles between 50 and 950 mV relative to a reversible hydrogen electrode are carried out at a speed of 5 mV/s and 1600 rpm and evaluated at 900 mV. The ratio of the product and the difference between limiting diffusion current and kinetic current at 900 mV is formed and standardized to the amount of platinum. This gives a mass-specific activity at 900 mV.

An activity of 130 mA/mg of Pt was measured in the case of the Vulcan-supported catalyst of comparative example 1, 112 mA/mg of Pt for the DenkaBlack-supported catalyst of comparative example 2 and 122 mA/mg of Pt for the catalyst according to the invention of example 2. This shows that virtually no decrease in activity is found despite the significantly lower surface area of the support. The alloy catalyst of example 3 displays an activity of 237 mA/mg of Pt.

### Example 5

Determination of the corrosion resistance of the catalysts by means of a rotating disk electrode

Apart from the oxidation resistance of the support, sintering of the catalyst particles can also occur and lead to a significant impairment of the activity. For this reason, a corrosion test of the catalyst system was also carried out. For this purpose, measurements were firstly carried out by means of a rotating disk electrode as described under example 4. 150 potential cycles between 500 and 1300 mV were then carried out at a speed of 50 mV/s and the activity was finally determined again. In the case of the Vulcan-supported catalyst of comparative example 1, the decrease in activity was 75%. In the case of the DenkaBlack-supported catalyst of comparative example 2, the decrease in activity was 47% and in the case of the catalyst according to the invention of example 2 the decrease was only 33%. The current-potential curves show the effect even more clearly. Thus, the curve of the oxidized Vulcan-supported catalyst is shifted by almost 1 mA at 900 mV, or by 30 mV at −1 mA, while the curves for the catalyst supported on the carbon black according to the invention R1 are virtually unchanged. This means that the shift to lower potentials is only 8 mV at −1 mA.

### Example 6

Color of the electrocatalyst layer

The color difference between a catalyst supported on standard carbon and a catalyst according to the invention can be observed visually. This difference can also be quantified, for example, by remission measurements. Here, both the unabsorbed light and the remitted light are measured. Standard carbon black is characterized by virtually complete absorption and a Vulcan-supported catalyst displays only very low remission values of about 2.5% in the visible region (up to about 750 nm). Catalysts according to the invention remit significantly more, and the remission value is at least 3.5%, usually about 4-4.5%, in the visible region.

Color values can be determined from the remission curves, and these are summarized in table 2 for catalysts supported on a carbon black according to the invention and for Vulcan XC72-supported catalysts. It can be seen that the catalysts supported on the carbon black according to the invention R1 and the carbon black according to the invention R1 have a color difference of at least 2 compared to Vulcan XC72. In the case of pure carbon black and catalysts having a content of 30% by weight and less, the color difference is even about 3.

TABLE 2
Color values

| | Color coordinates | | | |
|---|---|---|---|---|
| Catalyst/carbon black | L* | a* | b* | ΔE* |
| Vulcan XC72 | 33.2 | 0.1 | -0.6 | ref (2.9) |
| 30% Pt/XC72 | 33.6 | 0.0 | -1.3 | 0.8 (2.6) |
| Carbon black R1 | 36.1 | -0.1 | -0.8 | 2.9 (ref) |
| 20% Pt/R1 | 36.2 | 0.0 | -0.3 | 3.0 (0.5) |
| 20% Pt, 5% Ni/R1 | 36.5 | 0.2 | -0.5 | 3.3 (0.4) |
| 30% Pt/R1 | 36.5 | 0.0 | -0.7 | 3.3 (0.6) |
| 50% Pt/R1 | 35.3 | 0.0 | -1.0 | 2.1 (0.8) |

In the table, the carbon black Vulcan XC72 was used as reference (ref) in one case for determining the values of ΔE* and the carbon black according to the invention R1 was employed as reference (ref) for the values in brackets.

1. A catalyst, comprising:
a support and
a catalytically active material, wherein the support is a carbon support having a BET surface area of less than 50 m²/g.

2. The catalyst of claim 1, wherein the carbon support has a CTAB surface area of less than 50 m²/g.

3. The catalyst of claim 2, wherein a ratio of the BET surface area of the carbon support to the CTAB surface area of the carbon support is in a range from 1 to 1.1.

4. The catalyst of claim 1, wherein the the carbon support has an oil adsorption number in a range from 100 to 140 ml/100 g.

5. The catalyst according to claim 1, having a remission value greater than 2.5%.

6. The catalyst of claim 1, wherein a proportion of material which can be extracted by toluene from the carbon support is less than 1%.

7. The catalyst of claim 1, wherein the catalytically active material comprises a Group 10 metal, a transition metal, or an alloy of comprising a Group 10 metal and a transition metal.

8. The catalyst of claim 1, wherein the catalytically active material is platinum or an alloy comprising platinum.

9. The catalyst of claim 7, wherein the catalytically active material is an alloy comprising a Group 10 metal, and a proportion of the Group 10 metal in the alloy is in a range from 40 to 80 atom %.

10. The catalyst of claim 1, wherein the catalyst is a cathode catalyst.

11. The catalyst of claim 1, wherein the catalyst is suitable for use as an electrode catalyst in a fuel cell.

12. The catalyst of claim 8, wherein the catalytically active material is an alloy comprising platinum, and a proportion of the platinum in the alloy is in a range from 40 to 80 atom %.

13. The catalyst of claim 1, having a remission value greater than 3.5%.

14. The catalyst of claim 1, wherein the carbon support has a BET surface area in a range from 20 to 30 m²/g.

15. The catalyst of claim 14, wherein the carbon support has a CTAB surface area in a range from 20 to 30 m²/g.

16. The catalyst of claim 15, wherein a ratio of the BET surface area of the carbon support to the CTAB surface area of the carbon support is in a range from 1 to 1.1.

17. The catalyst of claim 16, wherein the catalytically active material comprises a Group 10 metal, a transition metal, or an alloy comprising a Group 10 metal and a transition metal.

18. The catalyst of claim 16, wherein the catalytically active material is an alloy comprising a Group 10 metal, and a proportion of the Group 10 metal in the alloy is in a range from 40 to 80 atom %.

19. The catalyst of claim 16, wherein the catalytically active material is an alloy comprising platinum, and a proportion of the platinum in the alloy is in a range from 40 to 80 atom %.

20. The catalyst of claim 19, wherein the proportion of platinum in the alloy is in a range from 50 to 80 atom %.
